(19) United States
(12) Patent Application Publication
(10) Pub. No.: US 2010/0208767 A1
(43) Pub. Date: Aug. 19, 2010

(54) Ear Thermometer using optical fiber transmission

(76) Inventor: Erik Chen, Taipei City (TW)

Correspondence Address: Erik, CHEN, P.O. Box 46-563, Taipei City, Taipei, 10499, TW

(21) Appl. No.: 12/378,445

(22) Filed: Feb. 17, 2009

(51) Int. Cl. G01J 5/00

(52) U.S. Cl. 374/131

(57) ABSTRACT

An ear thermometer using optical fiber transmission includes a housing, an optical fiber conductor, a thermal sensor, and a circuit board. When the ear thermometer is used to take a human body temperature, a convex surface at one end of the optical fiber conductor collects thermal radiation caused by the human body temperature inside a human auditory meatus, and the optical fiber conductor transmits the thermal radiation to an opposite end thereof so that a convex surface at the opposite end evenly scatters the thermal radiation toward the thermal sensor. Thereby the thermal sensor senses the thermal radiation and determines the human body temperature accordingly.

### BACKGROUND OF THE INVENTION

1. Technical Field

The present invention relates to ear thermometers and, more particularly, to an ear thermometer using optical fiber transmission.

2. Description of Related Art

FIGS. 1 and 2 show a probe portion 1 of a conventional infrared thermometer. In the probe portion 1, a hollow tubular wave guide 11 having a smooth, reflective inner surface is provided. When the probe portion 1 has its proximal end placed into a human external auditory meatus, the inner surface of the tubular wave guide 11 repeatedly reflects and thereby transmits thermal radiation caused by the human body temperature inside the auditory meatus to a thermal sensor 12 at a distal end of the probe portion 1. After receiving the human body temperature from inside the auditory meatus, the thermal sensor 12, basing on a difference between its own temperature and the human body temperature received from inside the auditory meatus, identifies a variation of human body temperature and then outputs temperature-related data to a circuit board 13 for an external display device to display a reading of the human body temperature. However, when inserted into the auditory meatus, the probe portion 1 inevitably contacts the auditory meatus. Since the initial temperature of the tubular wave guide 11 is typically lower than the human body temperature inside the auditory meatus, the tubular wave guide 11 itself may be slightly warmed up after the human body temperature of the internal auditory meatus is transmitted via the tubular wave guide 11 to the thermal sensor 12. Consequently, the raised temperature of the tubular wave guide 11 is also detected by the thermal sensor 12, thus resulting in an error in the human body temperature sensed. Besides, since the tubular wave guide 11 relies on its inner surface to reflect and transmit thermal radiation, the tubular wave guide 11 must be formed as a straight tube and thus limits the configuration of the probe portion 1 assembled therewith.

### SUMMARY OF THE INVENTION

In view of the shortcomings of the prior arts, the present invention herein provides an ear thermometer using optical fiber transmission. The ear thermometer has a probe portion primarily comprising a housing, an optical fiber conductor, a thermal sensor, and a circuit board. Therein, the optical fiber conductor has two ends each formed with a convex surface so that when a thermal radiation from a human auditory meatus reaches the optical fiber conductor, the convex surface at the proximal end of the optical fiber conductor collects and leads surrounding thermal radiation into the optical fiber conductor. Then the optical fiber conductor transmits the thermal radiation to its distal end so that the convex surface at the distal end evenly scatters the thermal radiation toward the thermal sensor, thereby fully passing the thermal radiation to the thermal sensor.

According to the present invention, the housing of the probe portion is configured as a movable structure so that the length by which the optical fiber conductor juts out from the housing is adjustable by moving the housing as needed. In addition, the part of the optical fiber conductor that juts out from the housing can be bent into a desired angle to meet practical needs in sensing, thereby allowing the optical fiber conductor to be easily placed into a human auditory meatus at different angles.

According to the present invention, the circuit board is settled among pins of the thermal sensor and has two surfaces each coated with a heat-dissipation layer, which serves not only to dissipate heat from the thermal sensor and the circuit board but also to prevent errors from occurring in temperatures sensed by the thermal sensor as a result of accumulated heat.

According to the present invention, the probe portion is detachable from the ear thermometer so that the probe portion can be inserted into a human auditory meatus alone, and the human body temperature detected from inside the auditory meatus is transmitted to the ear thermometer through a wireless transmission device in the probe portion, thereby enabling continuous monitoring of human body temperature.

### BRIEF DESCRIPTION OF THE DRAWINGS

The invention as well as a preferred mode of use, further objectives, and advantages thereof will be best understood by reference to the following detailed description of illustrative embodiments when read in conjunction with the accompanying drawings, wherein:

FIG. 1 is a schematic partial view of a conventional ear thermometer;

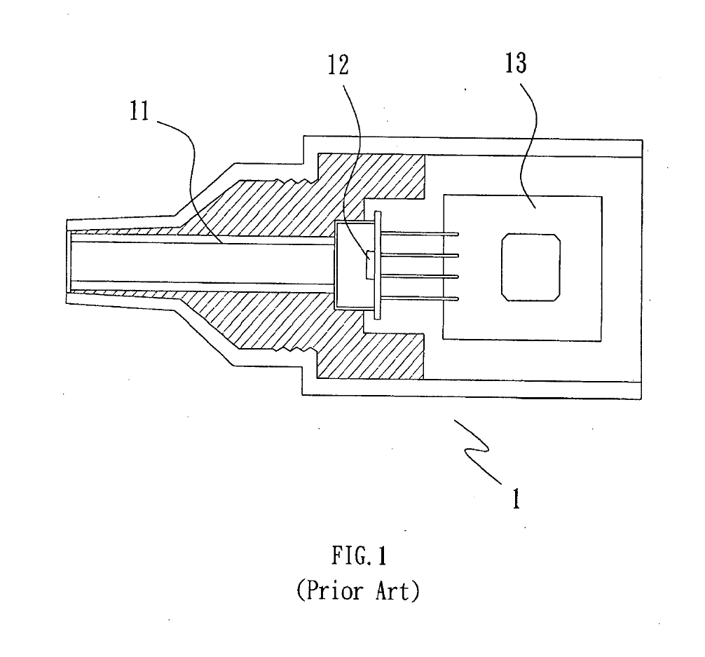

FIG. 2 is another schematic partial view of the conventional ear thermometer;

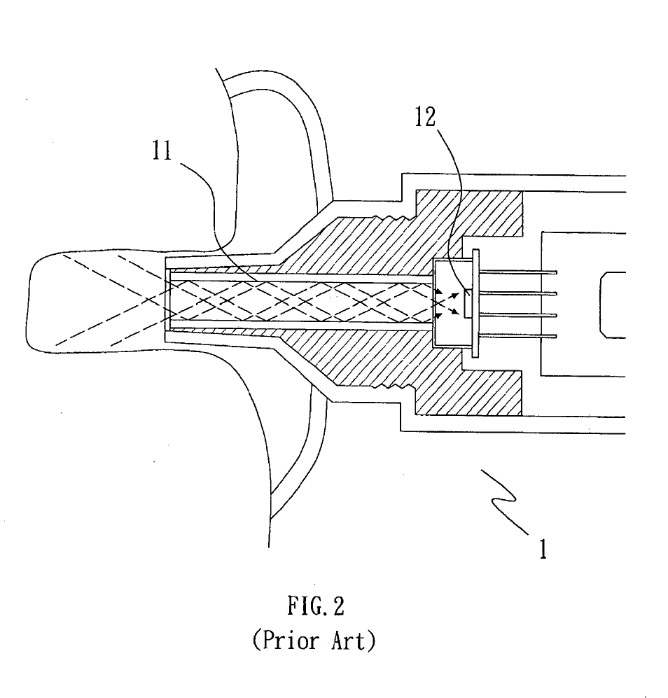

FIG. 3 is a cross-sectional view of a first embodiment of the present invention;

FIG. 4 is a schematic partial view of the first embodiment of the present invention;

FIG. 5 is a drawing showing application of the first embodiment of the present invention;

FIG. 6 is a further drawing showing application of the first embodiment of the present invention;

FIG. 7 illustrates a second embodiment of the present invention;

FIG. 8 is a drawing showing application of the second embodiment of the present invention;

FIG. 9 illustrates a third embodiment of the present invention;

FIG. 10 is a drawing showing application of the third embodiment of the present invention; and

FIG. 11 illustrates a fourth embodiment of the present invention.

### DETAILED DESCRIPTION OF THE PREFERRED EMBODIMENTS

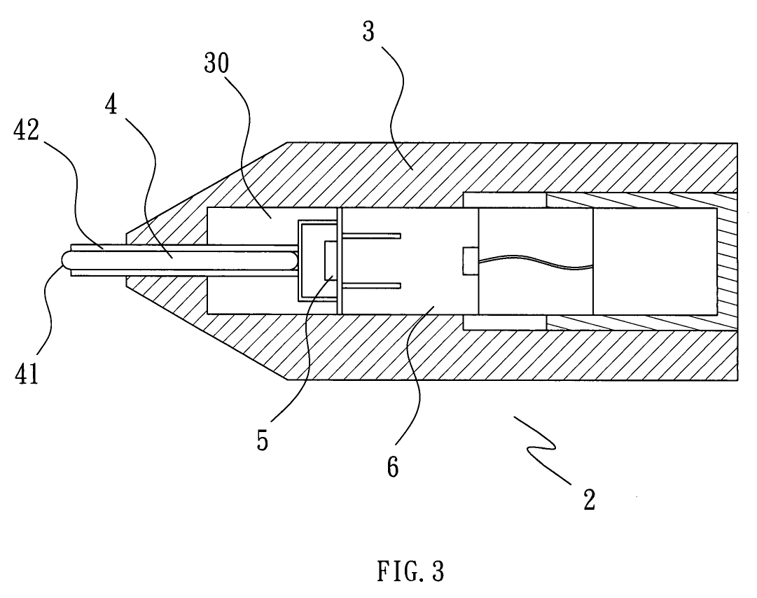

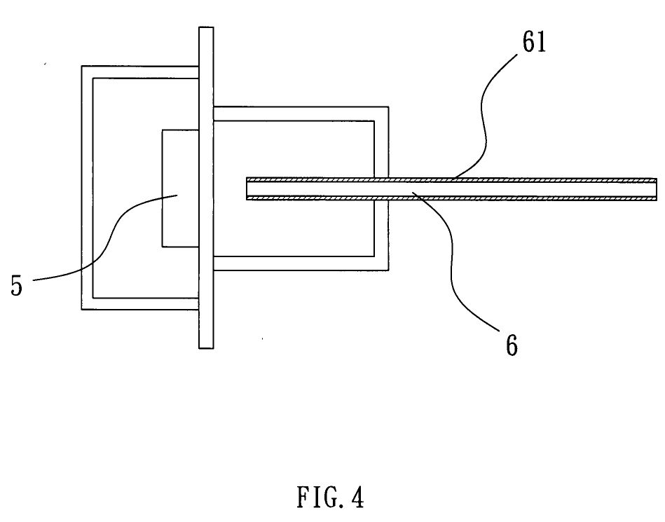

Please refer to FIGS. 3 and 4 for a cross-sectional view and a schematic partial view of an ear thermometer of the present invention, respectively. As can be seen in the drawings, the ear thermometer has a probe portion 2 including a housing 3, an optical fiber conductor 4, a thermal sensor 5 that may be a thermopile, a pyroelectric element, or a thermistor, and a circuit board 6. The optical fiber conductor 4, the thermal sensor 5, and the circuit board 6 are settled in an accommodating space 30 formed inside the housing 3. The optical fiber conductor 4 has two ends each formed with a convex surface 41 and is wrapped by a coat 42 made of an opaque flexible material. One said end of the optical fiber conductor 4 is connected with the thermal sensor 5, which in turn is conductively connected with the circuit board 6.

Besides, the thermal sensor 5 has four pins, and the circuit board 6 is settled among the four pins. In other words, each of two surfaces of the circuit board 6 is connected with two said pins of the thermal sensor 5. Also, the circuit board 6 has its two surfaces each coated with a heat-dissipation layer 61. By positioning the circuit board 6 among the four pins of the thermal sensor 5 and coating the two surfaces of the circuit board 6 with the heat-dissipation layers 61, heat on both the thermal sensor 5 and the circuit board 6 can be effectively dissipated. The housing 3 of the probe portion 2 is configured as a movable structure so that the length by which the optical fiber conductor 4 juts out from the housing 3 is adjustable.

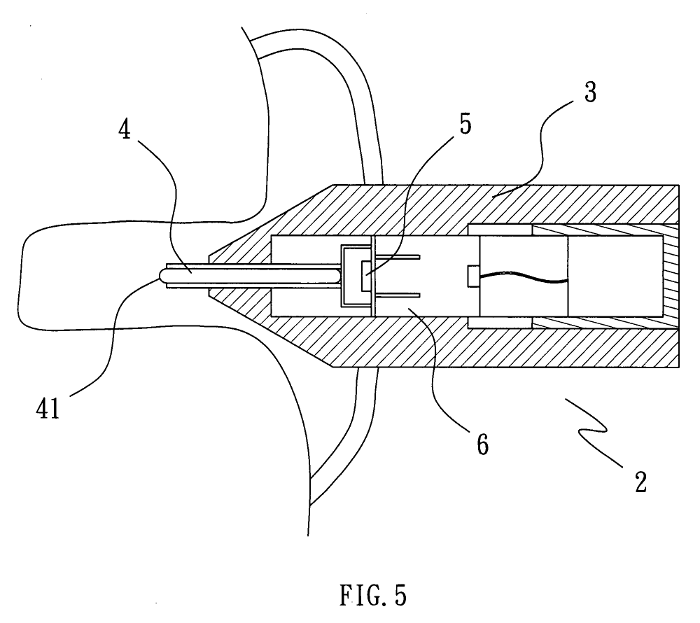

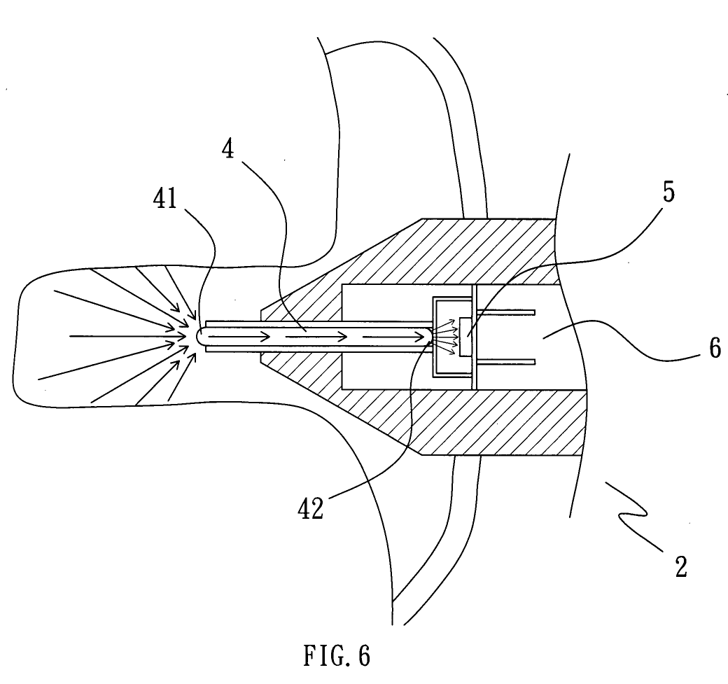

Referring to FIGS. 5 and 6, when the probe portion 2 of the ear thermometer is inserted into a human auditory meatus, the housing 3 has its end including the optical fiber conductor 4 placed in the auditory meatus. At this time, the convex surface 41 at the proximal end of the optical fiber conductor 4 collects and leads surrounding thermal radiation caused by a human body temperature inside the auditory meatus into the optical fiber conductor 4. Then the optical fiber conductor 4 transmits the thermal radiation to its distal end so that the convex surface 41 at the distal end evenly scatters the thermal radiation toward the thermal sensor 5, thereby passing the thermal radiation to the thermal sensor 5. After receiving the thermal radiation, the thermal sensor 5 generates a potential difference due to its own temperature variation and in consequence outputs a voltage output signal to the circuit board 6 so as to determine the accurate reading of the human body temperature.

As mentioned above, the circuit board 6 is positioned among the four pins of the thermal sensor 5, and the two surfaces of the circuit board 6 are coated with the heat-dissipation layers 61. This is because the thermal sensor 5 has its own temperature raised after receiving the thermal radiation from the auditory meatus, and while transmitting the voltage output signal through the pins, the thermal sensor 5 may also pass this raised temperature to the circuit board 6 as the pins themselves are warmed up. Now that the circuit board 6 is settled among the four pins of the thermal sensor 5 and has its two surfaces coated with the heat-dissipation layers 61, heat will not accumulate among the pins but is effectively dissipated. Hence, errors due to accumulated heat are prevented from occurring in temperatures sensed by the thermal sensor 5.

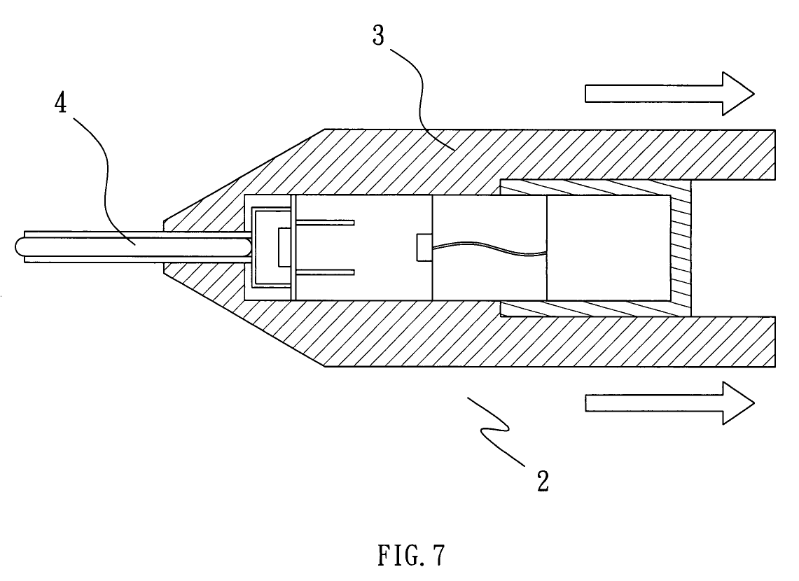

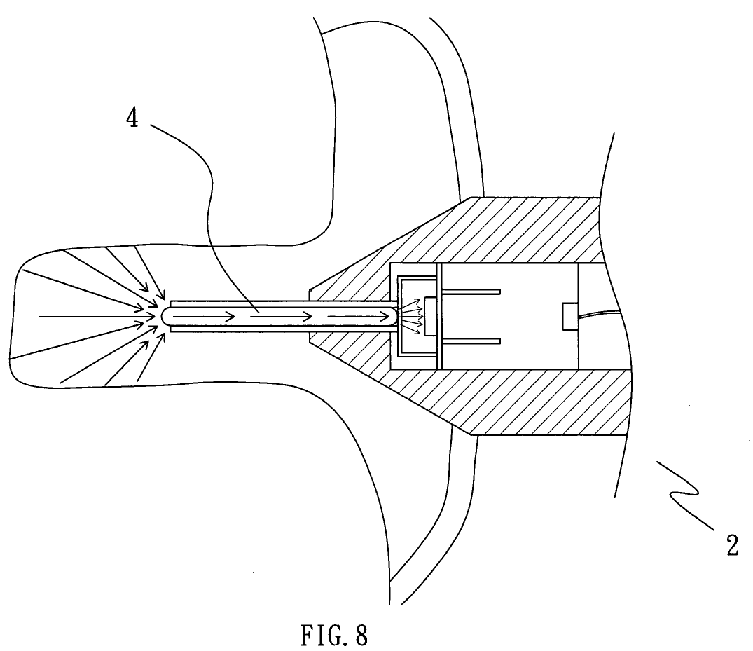

FIGS. 7 and 8 illustrate a second embodiment of the present invention. Therein, the housing 3 of the probe portion 2 is configured as a movable structure so that the length by which the optical fiber conductor 4 juts out from the housing 3 can be adjusted according to practical needs.

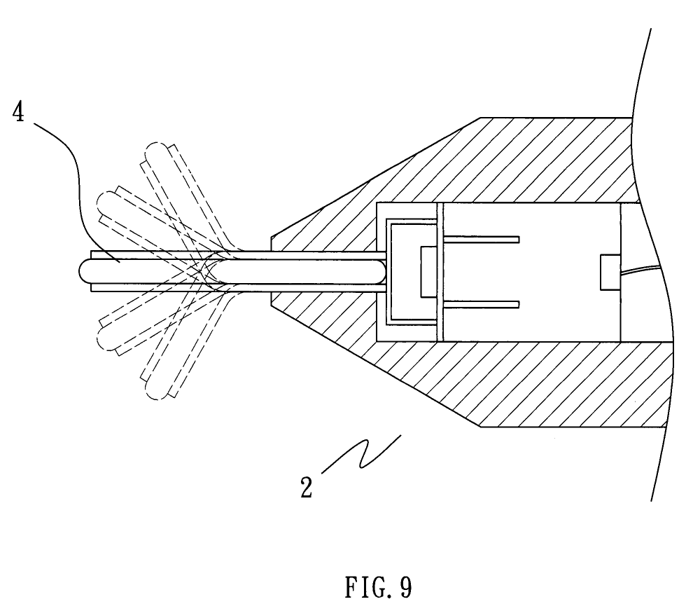

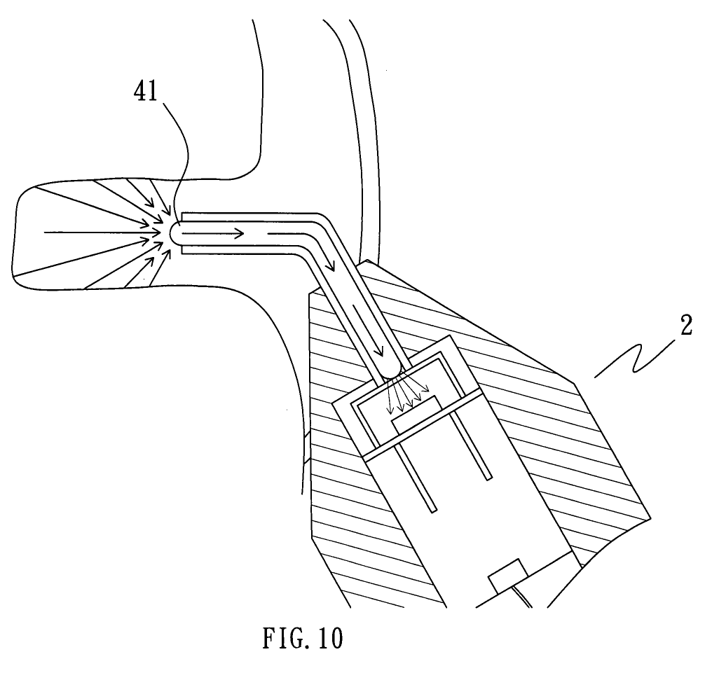

FIGS. 9 and 10 illustrate a third embodiment of the present invention. Therein, the optical fiber conductor 4 is flexible and is wrapped by the coat 42 made of an opaque flexible material. Thus, the part of the optical fiber conductor 4 jutting out from the housing 3 can be bent into a desired angle, allowing the optical fiber conductor 4 to be easily placed into a human auditory meatus at different angles.

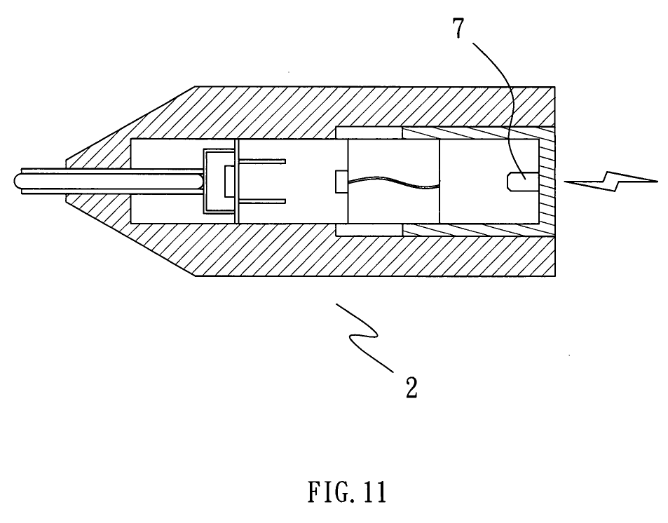

FIG. 11 illustrates a fourth embodiment of the present invention. Therein, the probe portion 2 is detachable from the ear thermometer so that the probe portion 2 can be put into a human auditory meatus alone, and the human body temperature detected from inside the auditory meatus is transmitted to the ear thermometer through a wireless transmission device 7 set inside the probe portion 2, thereby enabling continuous monitoring of human body temperature.

1. An ear thermometer using optical fiber transmission, the ear thermometer primarily comprising:
a housing having therein an accommodating space having a movable structure,
an optical fiber conductor settled in the accommodating space of the housing having two ends each formed with a convex surface, jutting out from the housing,
a thermal sensor settled in the accommodating space of the housing and connected with an end of the optical fiber conductor having four pins, and
a circuit board settled in the accommodating space of the housing being connected with two said pins of the thermal sensor,
wherein the optical fiber conductor receives a thermal radiation from inside a human auditory meatus and transmits the thermal radiation to the thermal sensor so that the thermal sensor detects the thermal radiation and determines a reading of a human body temperature accordingly.

2. (canceled)

3. (canceled)

4. The ear thermometer of claim 1, wherein the optical fiber conductor is wrapped by a coat made of an opaque flexible material which can be bent into a desired angle.

5. (canceled)

6. The ear thermometer of claim 1, wherein the thermal sensor is a thermopile, a pyroelectric element, or a thermistor.

7. The ear thermometer of claim 1, wherein the circuit board is coated with a heat-dissipation layer, therefore heat will not accumulate among the pins.

8. The ear thermometer of claim 1, wherein the ear thermometer comprises a wireless transmission device, set in the bottom of the probe portion.
